(19) United States
(12) Patent Application Publication
(10) Pub. No.: US 2008/0140788 A1
(43) Pub. Date: Jun. 12, 2008

(54) METHOD FOR COMMUNICATION FORWARDING

(75) Inventors: Marc Stanley Carter, London (GB); Lucas William Partridge, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/859,694

(22) Filed: Sep. 21, 2007

(30) Foreign Application Priority Data
Dec. 9, 2006 (GB) 0624604.5

(51) Int. Cl. G06F 15/16; G06F 17/30

(52) U.S. Cl. 709/206; 707/5

(57) ABSTRACT

A method for communication forwarding is provided. The method includes determining if a target contact for a communication is unavailable, and ascertaining a plurality of alternative contacts with a relationship to the target contact. The relationship may be a physical proximity and/or a social proximity of the alternative contact to the target contact. The method may include ordering the alternative contacts by their strength of relationship with the target contact.

### CROSS REFERENCE TO RELATED APPLICATIONS

This application is based upon and claims the benefit of priority from foreign application number GB0624604.5, which has a priority date of Dec. 9, 2006. The entire contents of GB0624604.5 are incorporated herein by reference.

### BACKGROUND OF THE INVENTION

This invention relates to the field of communication forwarding. In particular, it relates to forwarding a communication to an alternative contact when the target contact is unavailable.

Contact with a person may be made by various different current communication technologies, including by telephone, instant messaging, email, etc. When a person is unavailable, they may not answer an incoming communication, or a pre-recorded or standard message may be played or sent to the originator stating that the person is unavailable. There may be the opportunity to leave a message or to be transferred to another designated person, such as a secretary or assistant. However, the designated person may also be unavailable.

There are occasions when an urgent response is required and leaving a message may not be appropriate. The target contact may not be the only person who can provide a response. If the target contact has his usual work position geographically located near the communication originator, the originator may simply walk around to the target contact's work position and ask someone nearby when the target contact will be back. The originator may even address his question or issue to a nearby person instead of the target contact, as they may be able to help if they are part of the same work or social group.

The problem arises if the target contact is geographically far away from the originator, or if it is impractical for the originator to go and physically find a neighbour of the target contact.

There is a known concept of hunt groups in which a group of people log on to a communication technology as members of a group. If a call or message is made to anyone within the group and the call goes unanswered, it is diverted to another member of the group, and so on, until the call or message is answered. Hunt groups are popular devices in call or service centres to make sure a new customer call gets answered before the customer hangs up. However, the hunt group has to be predefined, even if people can dynamically join or leave it by logging on or off.

EP 0924919 discloses an environment in which members of a business group form a hunt group. If a calling party calls the business group, the hunt group first directs the incoming call to a particular business group member who is known to deal with the calling party. If the line is busy or there is no answer, the call is directed to a second person in the hierarchy who is known to the calling party. This use of hunt groups is based on a hierarchy of the relationship between a calling party and the members of the business group.

It is an aim of the present invention to provide a forwarding method and system based on a physical and/or social proximity of alternative contacts to the target contact.

### BRIEF SUMMARY OF THE INVENTION

According to a first aspect of the present invention there is provided a method for communication forwarding, comprising: determining if a target contact for a communication is unavailable; ascertaining a plurality of alternative contacts with a relationship to the target contact; and ordering the alternative contacts by their strength of relationship with the target contact.

The method may include providing the ordered alternative contacts to a user for selection. The method may include automatically routing the communication to the first ordered alternative contact.

The relationship may be the geographical proximity (also referred to as the physical proximity) of an alternative contact to the target contact. Alternatively or additionally, the relationship may be a social proximity of an alternative contact and the target contact. The social proximity may be one of a social, business, corporate, or organisational relationship between an alternative contact and the target contact.

The relationship may further alternatively or additionally be a frequency of communication contact between an alternative contact and the target contact. The communication may be one of a telephone call, an instant message, an email, an SMS (short messaging service) message, or a pager message. The communications may be monitored and a structure maintained of the relationships between contacts. The structure may be dynamically updated as relationships change.

The strength of relationship may be a comparative measure of the relationship of each of the plurality of alternative contacts to the target contact.

The geographical proximity may be determined by positioning technology or technologies of the target contact's and the alternative contact's communication apparatus. The communication apparatus may be mapped to contact details.

The method may include generating communication messages to inform an originator of the communication of the routing.

The method may be applied recursively if no alternative contacts are available, including designating an alternative contact as the new target contact and applying the method for the new target contact.

According to a second aspect of the present invention there is provided a method for communication forwarding, comprising: determining if a target contact for a communication is unavailable; ascertaining a plurality of alternative contacts with a relationship to the target contact, wherein the relationship is the geographical proximity of an alternative contact to the target contact.

### BRIEF DESCRIPTION OF THE DRAWINGS

Embodiments of the present invention will now be described, by way of examples only, with reference to the accompanying drawings in which:

FIGS. 1A and 1B are schematic diagrams showing physical and social proximity in accordance with one embodiment of the present invention;

FIG. 2 is a flow diagram showing a method in accordance with one embodiment of the present invention;

FIGS. 3A, 3B and 3C are flow diagrams of alternative aspects in accordance with one embodiment of the present invention;

FIG. 4 is a block diagram of a system in accordance with one embodiment of the present invention;

FIG. 5 is a block diagram of a first embodiment in accordance with the present invention;

FIGS. 6A and 6B are flow diagrams of a method in accordance with a first embodiment of the present invention;

FIG. 7 is a block diagram of a second embodiment in accordance with the present invention;

FIGS. 8A and 8B are flow diagrams of a method in accordance with a second embodiment of the present invention;

FIG. 9 is a block diagram of a third embodiment in accordance with the present invention; and

FIG. 10 is a flow diagram of a method in accordance with a third embodiment of the present invention.

### DETAILED DESCRIPTION OF THE INVENTION

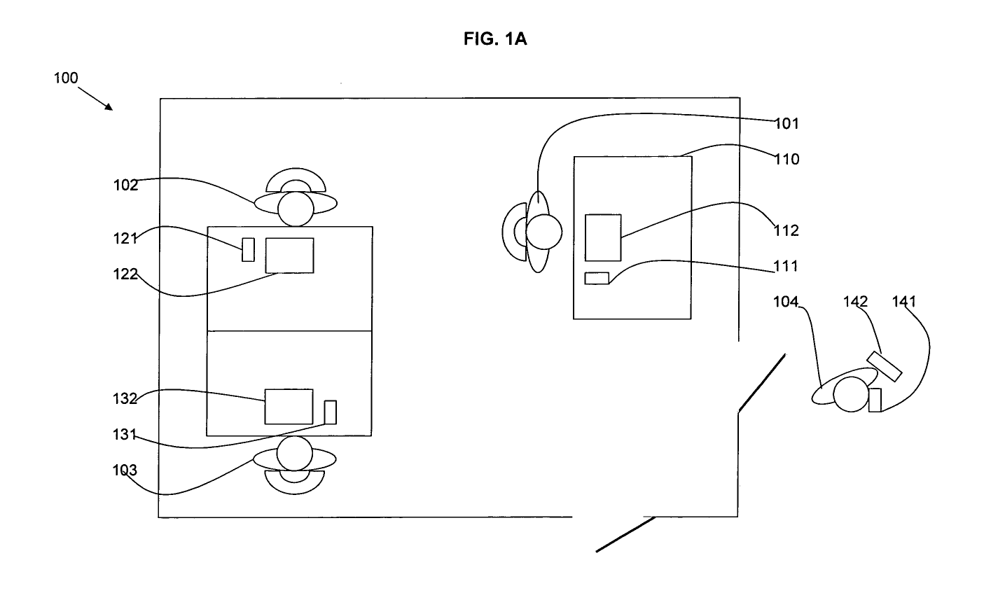

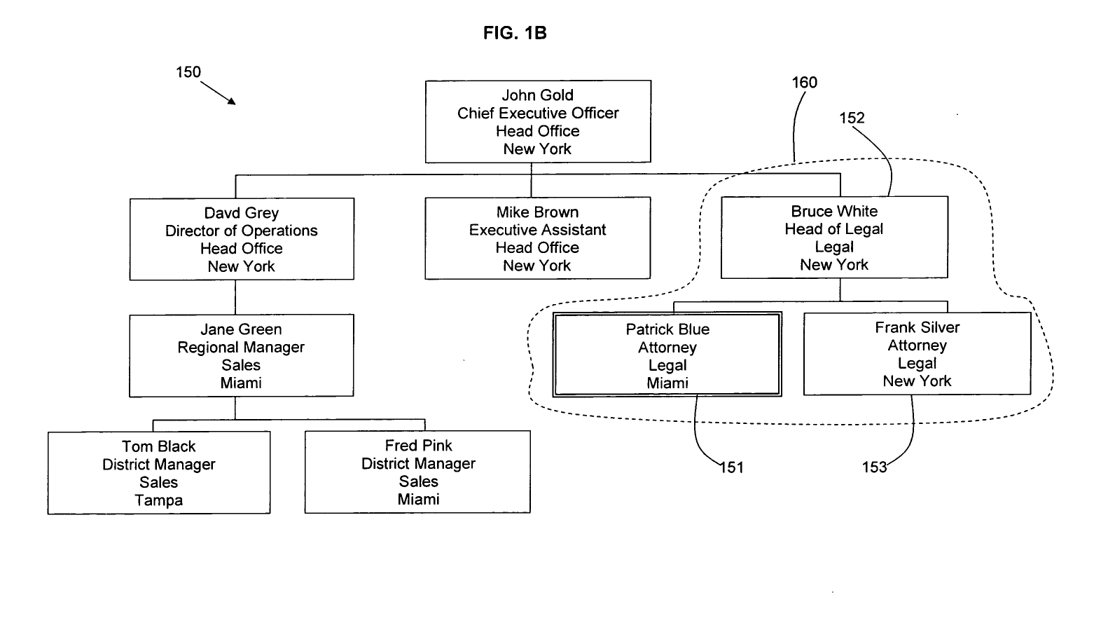

Referring to FIG. 1A, an environment 100 is shown in which a target contact 101 has a geographical location. Other contacts 102, 103, 104 may be located in geographic proximity to the target contact 101. The term contact is used to describe a person with at least one communications apparatus, or a communications apparatus itself, with which a user may establish communication contact via a communications technology.

If the contacts 101-104 are people, they may have more than one form of communication apparatus assigned to them. For example, a contact 101-104 may have a mobile telephone, a landline telephone, a laptop computer, a desktop computer, a PDA (personal digital assistant), a pager, etc.

In FIG. 1A a target contact 101 may have his communications apparatus in the form of, for example, a telephone 111 and a laptop 112, at his usual desk location 110. However, the target contact 101 may not be at his desk, or may be at his desk but not wanting to be disturbed and therefore not answering his communication technologies, such as the telephone, email or instant messaging messages.

The other contacts 102, 103, 104 may be in physical proximity to the target contact 101 and may also have communication apparatus 121, 122, 131, 132, 141, 142. However, the physical proximity of the other contacts 102, 103, 104 may or may not indicate that they know the target contact 101 or that they could help with answering a communication aimed at the target contact 101. For example, as illustrated in FIG. 1A, one of the contacts 104 in close physical proximity is actually just walking past the office door of the target contact 101.

The closest physical proximity determined by some forms of positioning technology might not be on the same floor as the target contact, so the positioning technology may need to triangulate the position of the nearest neighbors to determine which of them are located on the same floor.

In addition to the concept of physical proximity, a target contact may also have social proximity to other contacts. The social proximity may take the form of any social relationship. For example, the contacts may work on the same work project, may be in the same department of a corporate or organization structure, may be in a sports team, may be members of a club or society, may be in regular contact via email or some other form of communication, etc.

FIG. 1B shows a schematic diagram of a target contact 151 with other contacts 152, 153 which have a social proximity to the first contact 151 as they are all in the legal department 160 of a corporate structure 150. The department 160 has members who are geographically distributed, as the target contact 151 is in Miami whilst the other members 152, 153 of the legal department are in New York.

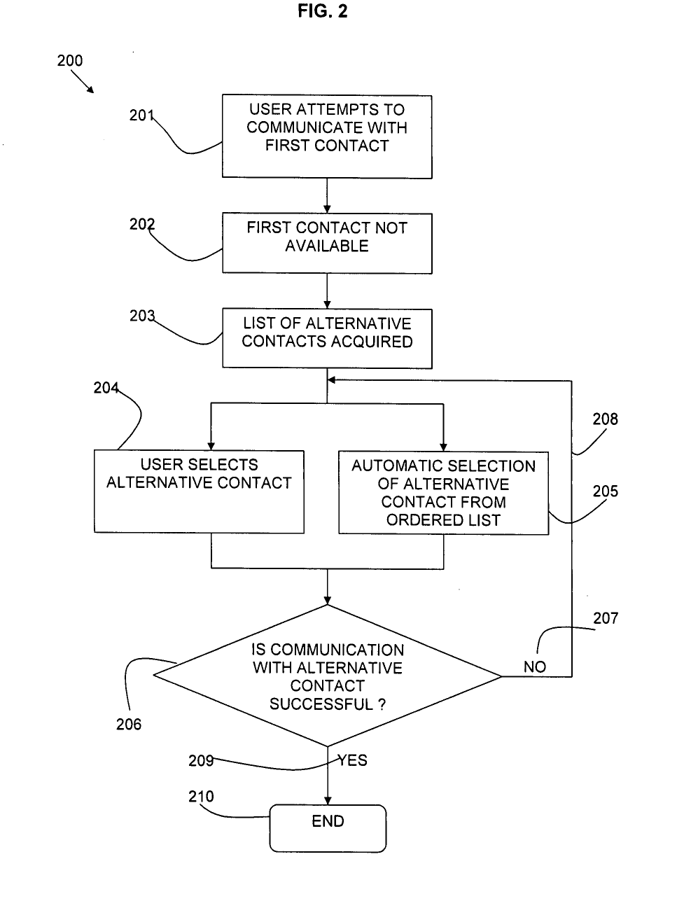

FIG. 2 is a flow diagram 200 of the overall method of a preferred embodiment of the present invention. A user attempts to communicate 201 with a target contact by means of a communications technology. The communications technology determines 202 that the target contact is not available. The communications technology may determine that the target contact is not available at the location of the target contact's client implementation of the communications technology.

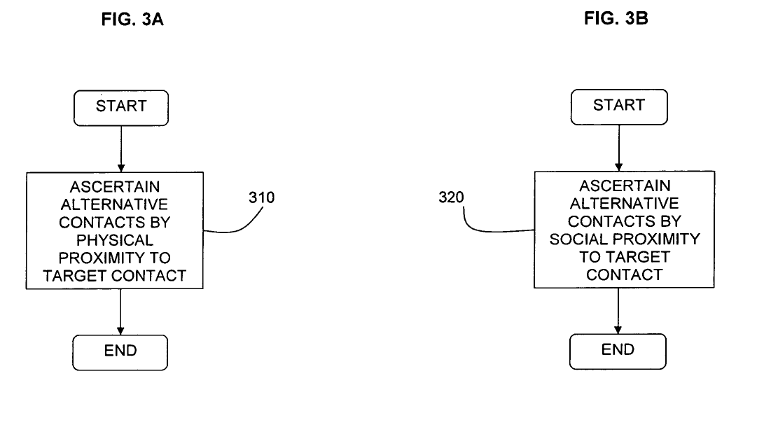

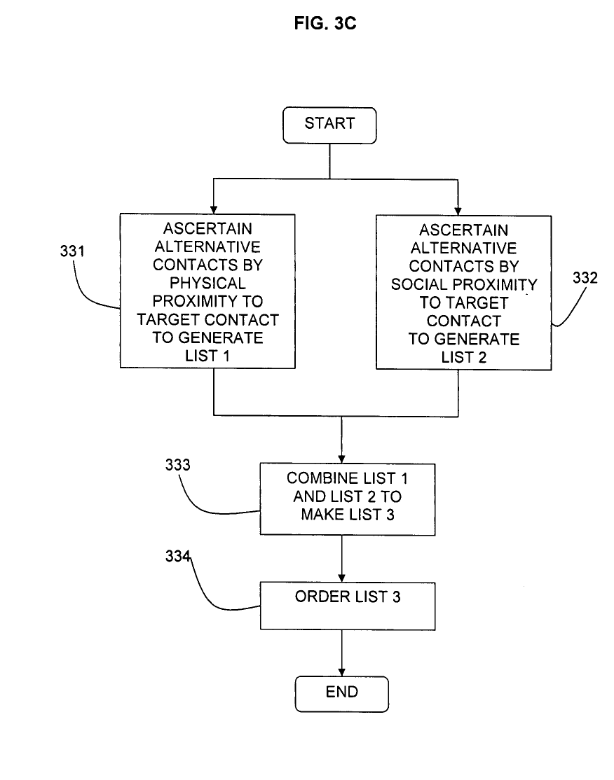

A list of alternative contacts is acquired 203. This may be carried out by the alternative methods as shown in FIGS. 3A to 3C. The user is either provided with the list of alternative contacts from which to select 204 an alternative contact to try to communicate with, or the user is automatically diverted 205 to an alternative contact from the list.

It is determined if the new communication attempt is successful 206. If the communication attempt is unsuccessful 207, the method loops 208 for the user to select another alternative contact or to try the next alternative contact in the list. If the communications attempt with the alternative contact is successful 209, the method ends 210.

A user may be provided with a number of alternative contacts and, optionally, may be provided with an indication of the relationship of the alternative contact to the first contact. Alternatively, the alternative contacts may be automatically ordered on a basis of the strength of relationship with the first contact and the alternative contacts in the list automatically tried in order.

Referring to FIGS. 3A to 3B, the step of FIG. 2 of acquiring 203 a list of alternative contacts may be carried out by different contact evaluation methods.

In one embodiment shown in FIG. 3A, the alternative contacts may be determined based on the physical proximity 310 of contacts to the first contact as illustrated in FIG. 1A. The physical proximity may be determined by some form of positioning technology, for example, GPS (geographical positioning system).

In another embodiment shown in FIG. 3B, the alternative contacts may be determined based on social proximity 320 to the first contact as illustrated in FIG. 1B. As described above in relation to FIG. 1B, the social proximity may be work based, interest based, sports based, or socially based.

In a further embodiment shown in FIG. 3C, a combination of physical and social proximity is used. This has the benefit of determining a list of alternative contacts which are nearby to the first contact and have a shared social interest.

A first list is generated 331 of alternative contacts in physical proximity to the first contact. A second list is generated 332 of alternative contacts with a social proximity to the first contact. The first and second lists 331, 332 are combined 333 and ordered 334 to make a preferred list of contacts.

The described method and system propose that, if a communications attempt such as a telephone call or an instant message to a target contact is unsuccessful, then it is determined who is physically near the target contact and/or who is socially close to the target. For example, social proximity may be as a result of working on the same project, being a close friend, being in frequent email communication with the target, etc. The physical proximity determination may be implemented using Bluetooth, IR (infrared data transmission), WiFi, WLAN (wireless local area networks), or GPS to ascertain contacts' current positions, or a database of recorded work locations for contacts.

The physical proximity may be used as neighbors of the target contact may know the target contact's whereabouts. The social proximity aims to select an alternative contact who is either likely to know the target contact's whereabouts or may be able to help the user themselves. For example, a company database could provide social information from which it may be determined that John may sit closer to the target but is on a different team, whereas Mary sits further away but is in the same team and so may be more likely to know the whereabouts of the target contact or to address the caller's query successfully.

Social proximity may also be manually edited by a target to refer people to a secretary, for example, or away from people who do not like to be disturbed. Similarly, people may exclude themselves from being an alternative contact for someone who is very popular. They would do this to avoid frequent interruption by callers who have been diverted from the popular person.

If the system determines that there are no detectable neighbors in physical proximity, then it may default to hunting for people by social proximity instead and vice versa.

A large number of different permutations and combinations of one or both of physical and social proximity methods are possible.

Some examples of physical proximity include the physical desk location gained from a central database, a wireless proximity of mobile telephones based on Bluetooth technology, wireless proximity of other laptops using Bluetooth, WLAN or VOIP (voice over Internet protocol) telephones, computers on the same sub-network. An example combination is to use wireless connectivity to determine a current location, then look up neighbors from a central database of physical desk locations.

Some examples of social proximity include a management structure (same manager, same team, related job title, etc.) from a central database, email use between parties, pre-defined Bluetooth connections between neighbors, previous manually transferred telephone calls between parties, etc.

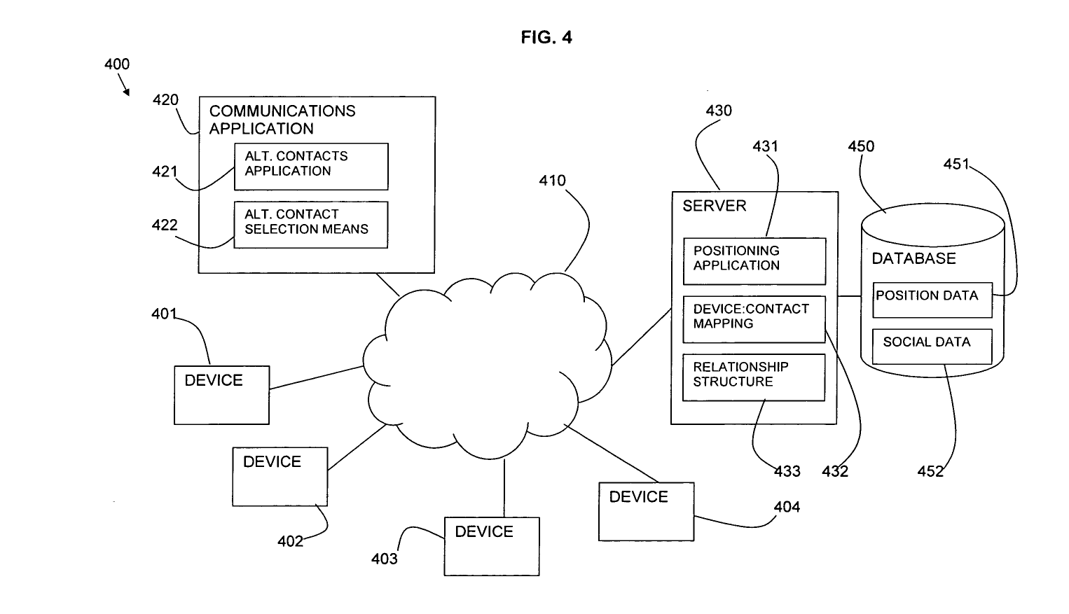

Referring to FIG. 4, a system 400 is shown in which the described method may be implemented. A plurality of devices 401-404 are connected via a network 410. The devices 401-404 may be any form of devices that are able to receive and transmit communications using a communications technology operated by a communications server 420. The devices 401-404 may optionally be able to transmit their position to a positioning application 431 provided on a server 430.

The communications server 420 includes an alternative contacts application 421 for providing alternative contacts when a target contact is unavailable. The alternative contacts application 421 may be instigated when a communication with a target contact fails and obtains a list of alternative contacts and provide a selection means 422 to a user or may automatically divert a communication to an alternative contact.

The target contact and alternative contacts are designated to devices 401-404 and a mapping 432 is provided accessible from a server 430 mapping the contacts to devices 401-404. A relationship structure (for example, a hierarchy or table) 433 is also accessible from a server 430 which may be dynamically updated from social or physical proximity data.

A database 450 may contain fixed position data 451 for contacts or devices which may be referred to as well or instead of variable positioning data from the positioning application 431. Known social structures 452 may also be stored on a database 450.

FIG. 4 shows the applications for positioning 431, mapping 432, and dynamic hierarchies 433 as being on a single server 430; however, these may be distributed across the network 410. Similarly, more than one database 450 may be accessed from different locations across the network 410.

Various example embodiments are now described illustrating the wide range of different applications for the proposed method.

A first embodiment is provided in which a user attempts to communicate with a target contact by means of a telephone call. In this embodiment, alternative contacts are provided based on a combination of the physical proximity of the alternative contacts to the target contact and the social proximity based on the frequency of email communication of the alternative contacts with the target contact. A modified embodiment could alternatively use either only the physical proximity or only the social proximity.

A second embodiment is provided in which a user attempts to communicate with a target contact by means of an instant message. In this embodiment, alternative contacts are provided based on a combination of the physical proximity of the alternative contacts to the target contact, the desk location of the alternative contacts, and the social proximity in an organization structure of the alternative contacts and the target contact. A modified embodiment could alternatively use only one of the physical proximity, the desk location, or the social proximity.

A third embodiment is provided in which a server attempts to communicate with a target contact in the form of a weather sensor by means of enterprise messaging. In this embodiment, alternative contacts are provided based on the physical proximity of the alternative contacts to the target contact.

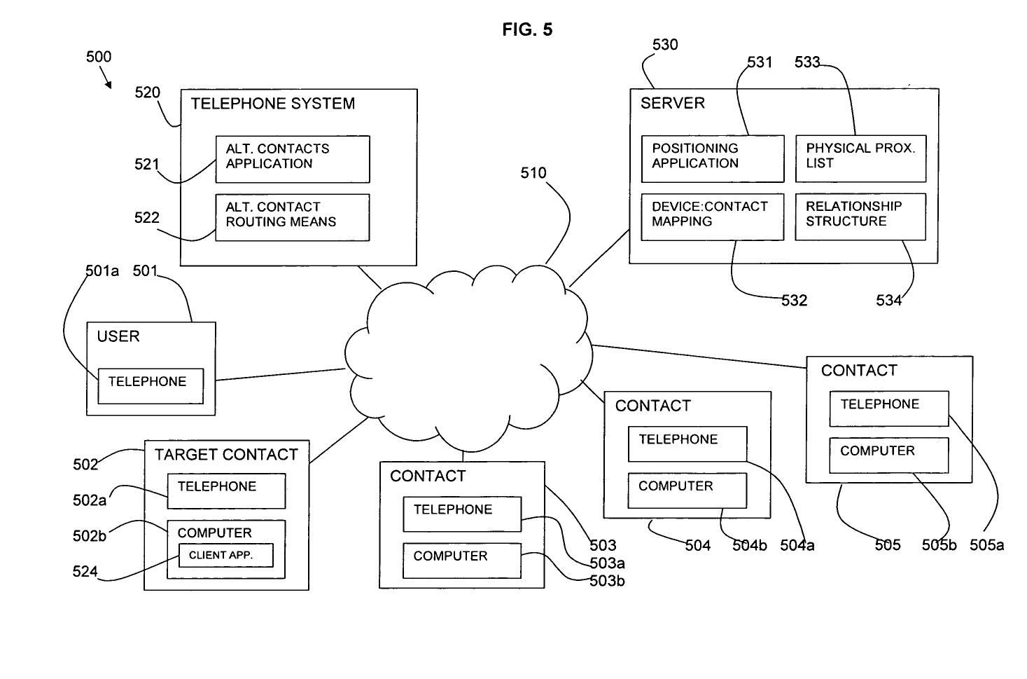

Referring to FIG. 5, a block diagram shows a system 500 for implementing the first example embodiment. A user 501 having a telephone apparatus 501a wishes to communicate with a target contact 502 by a telephone conversation. Multiple alternative contacts 503, 504, 505 may be physically positioned near or remote from the target contact 502. Each contact 502-505 has communication apparatus in this embodiment in the form of a telephone 502a-505a and a computer 502b-505b. Computers 502b-505b communicate via a network 510. The telephone apparatus 502a-505a may also use a network 510 or may have their own bespoke communication technology.

A telephone communication system 520 includes an alternative contacts application 521 which determines if a target contact is unavailable and selects alternative contacts. The telephone communication system 520 includes a re-routing function 522.

Accessible via the network 510 and provided on one or more servers 530 are the services of a positioning application 531, a mapping application of contacts to apparatus 532, an ordered list of physical proximity of alternative contacts 533, and an ordered list of social proximity of the alternative contacts in the form of a relationship structure 534.

A client application 524 of the alternative contacts application is provided on the target contact's computer 502b. The client application 524 registers with the server 530 to indicate that it is online and belongs to the user 502. The client application 524 updates any records with the services 531-534 provided on the server 530.

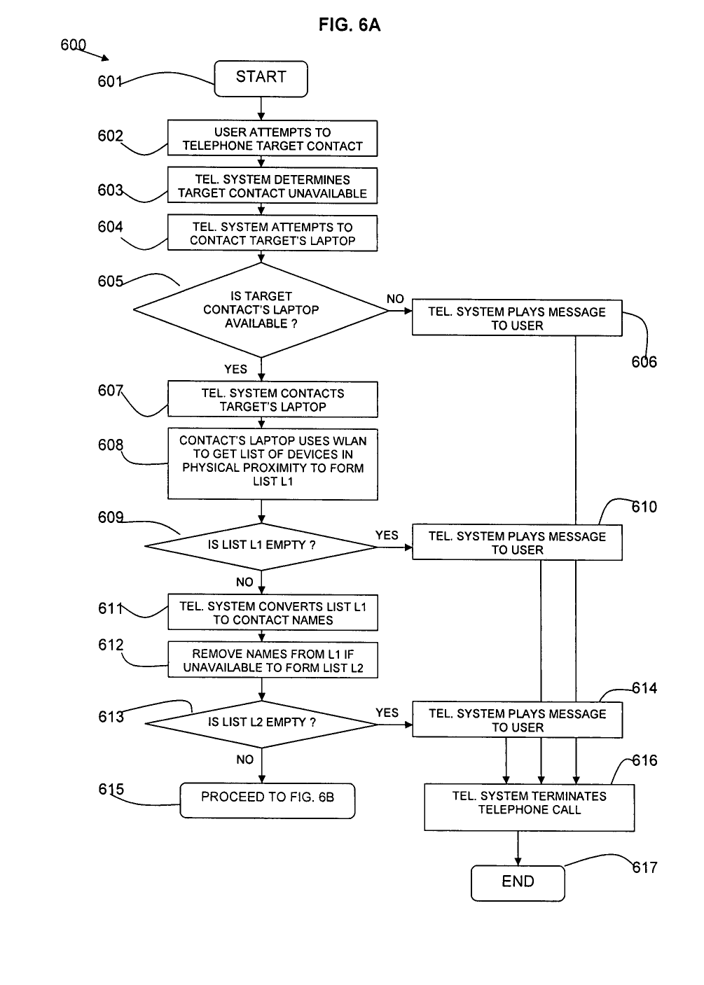

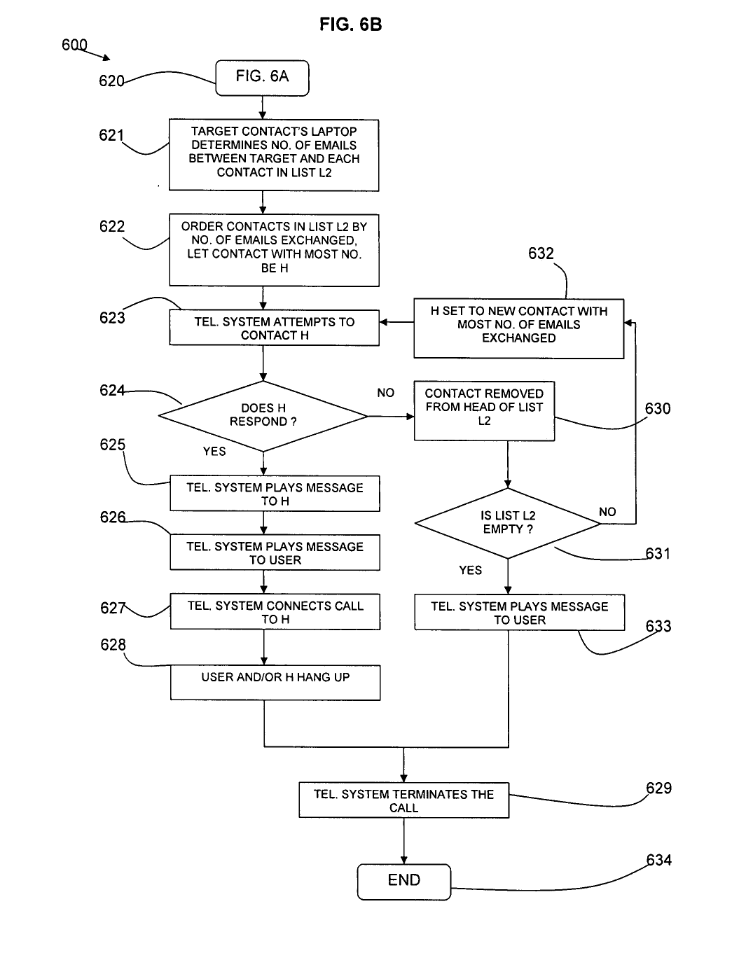

FIGS. 6A and 6B show flow diagrams 600 of a method in accordance with the first embodiment.

The method starts 601 when a user attempts to telephone a target contact 602. The telephone communication system determines that the target contact is unavailable 603. For example, the telephone may be on voice mail, engaged in another call, or may not be answered after a pre-determined time or number of rings. The telephone communication system plays the user a message (for example, a voice synthesized message):

“<Target contact> is not available. Attempting to contact someone in close proximity to <target contact>'s laptop. Please hold.”

The telephone communication system attempts to contact the target contact's laptop 604 by querying the mapping of contacts to apparatus. If the phones themselves had WLAN or another positioning technology, they could be used to find phones of alternative contacts directly.

It is determined 605 if the target contact's laptop is available. If it is not available, the telephone communication system plays a message to the user 606:

“It is not possible to determine who is in close proximity to <target contact>. Please leave a message or try again later.”

If it is available, the target contact's laptop is contacted 607.

The target contact's laptop uses WLAN to get a list of MAC (Media Access Control) addresses which are unique identifiers attached to networked equipment of other laptops in physical proximity to the target contact's laptop 608. This results in list L1.

Various methods are known for obtaining positioning information. The described embodiment refers to using WLAN. There are different ways of using WLAN to track locations namely, closest access point, triangulation and RF fingerprinting. The closest access point method finds devices within the total coverage area of a single access point. This is a simple method but not very accurate. Triangulation uses multiple access points to find a device based on the received signal strength of the device at each access point. RF fingerprinting is more comprehensive than triangulation and other access point methods. RF prediction is used to create a grid mapped to a floor plan that includes all physical characteristics and access points in a given area.

It is determined if list L1 is empty 609. If so, the telephone communication system plays a message to the user 610:

“No-one can be detected in close proximity to <target contact>. Please leave a message or try again later.”

If list L1 is not empty, the target laptop cross-references the list of MAC addresses in L1 against a list of names to identify the owners of the neighboring machines 611. List L1 now comprises a list of people's names.

As an optional step, the telephone communication system may remove anyone in list L1 who is on voice mail or engaged in another call 612. This results in list L2.

It is determined if list L2 is empty 613. If so, the telephone communication system plays a message to the user 614:

“No-one in close proximity to <target contact> is available to answer your call. Please leave a message or try again later.”

If the list L2 is not empty, the method proceeds 615 to FIG. 6B.

In each of the cases in which the telephone communication system plays a message regarding the unavailability of an alternative contact 606, 610, 614, the communication system terminates the call 616 and the method ends 617.

FIG. 6B proceeds from FIG. 6A 620. The target contact's laptop queries its email client to determine the number of emails exchanged between the target contact and each person in list L2 621. The people in list L2 are ordered according to the number of emails exchanged, with the most frequent correspondent placed at the head of the list 622. Let the person at the head of the list be called H.

The telephone communication system attempts to contact H 623. It is determined 624 if H answers within a pre-determined number of rings. If H answers, the telephone communication system plays a message to H 625:

“This caller attempted to ring <target contact> who is unavailable. This caller has been redirected to you automatically.”

The telephone communication system also plays a message to the user 626:

“<H> has been located closed to <target contact>'s laptop. Your call will be automatically redirected to <H> now.”

The telephone communication system automatically connects the user's call to H 627. After the conversation, the user or H disconnect 628 and the telephone system terminates the call 629.

If it is determined at step 624 that H does not answer, the person is removed from the head of the list L2 630. It is determined if list L2 is empty 631. If it is not empty, H is set to be the new person at the head of the list L2 632 and the method loops to step 623 and an attempt is made to contact H.

If list L2 is empty, the telephone communication system plays the user a message 633:

“No-one in close proximity to <target contact> is available to answer your call. Please leave a message or try again later.”

The telephone communication system then terminates the call 629 and the method ends 634.

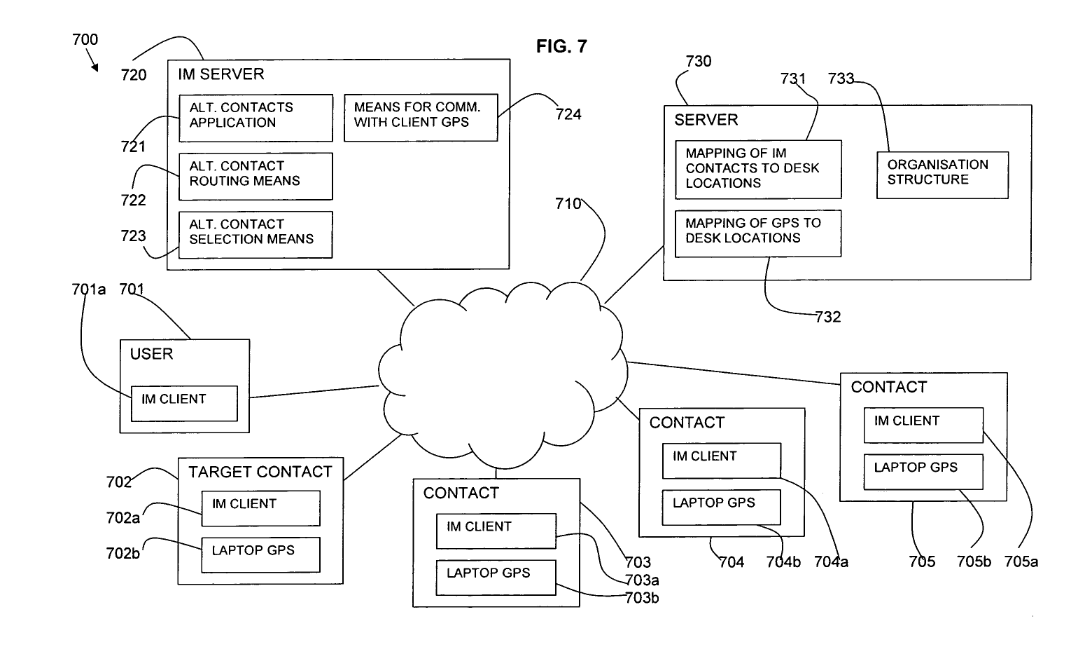

Referring to FIG. 7, a block diagram shows a system 700 for implementing the second example embodiment. A user 701 wishes to communicate with a target contact 702. Multiple alternative contacts 703, 704, 705 may be physically positioned near or remote from the target contact 702. The user 701 and each contact 702-705 has an instant messaging client 701a-705a. The IM clients 702a-705a may be provided on a computer having GPS or other positioning technology means 702b-705b. The IM clients 702a-705a are able to communicate with the GPS software 702b-705b by means of, for example, a plug-in written for the IM client software.

An instant messaging server 720 includes an alternative contacts application 721 which determines if a target contact is unavailable and selects alternative contacts. The instant messaging server 720 includes a re-routing function 722 or an alternative contact selection means 723 which may be provided on a GUI. The IM server includes a means 724 for communication with a client to determine its GPS coordinates.

Accessible to the instant messaging server 720 via a network 710 and provided on one or more servers 730 are a mapping of IM contacts to desk locations 731 and a mapping of GPS coordinates to desk locations 732. The mapping of IM contacts to desk locations 731 may be ordered by proximity. An organization structure 733 is also provided on a server 730.

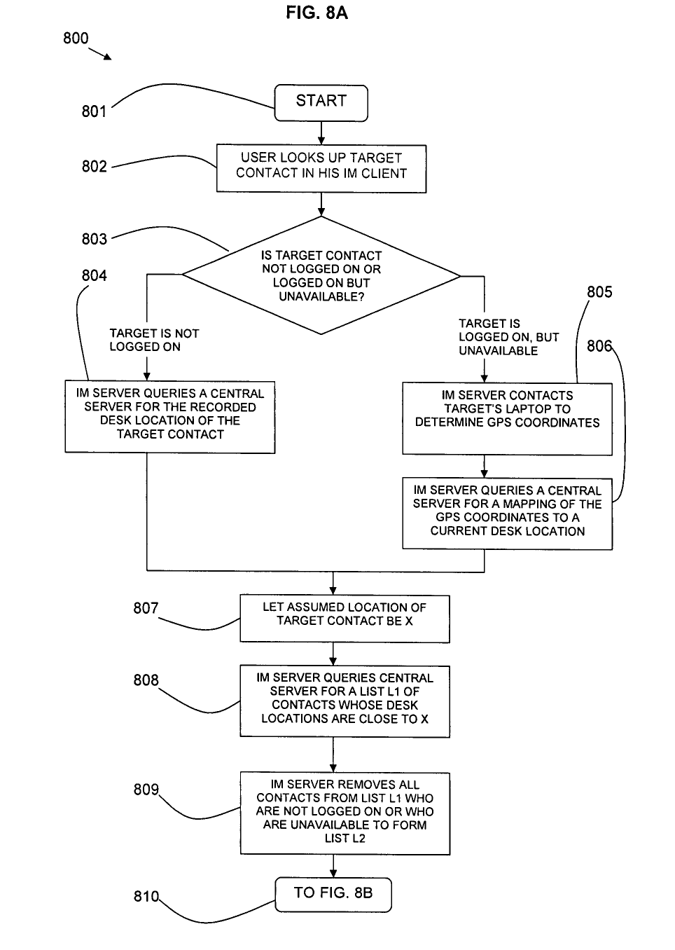

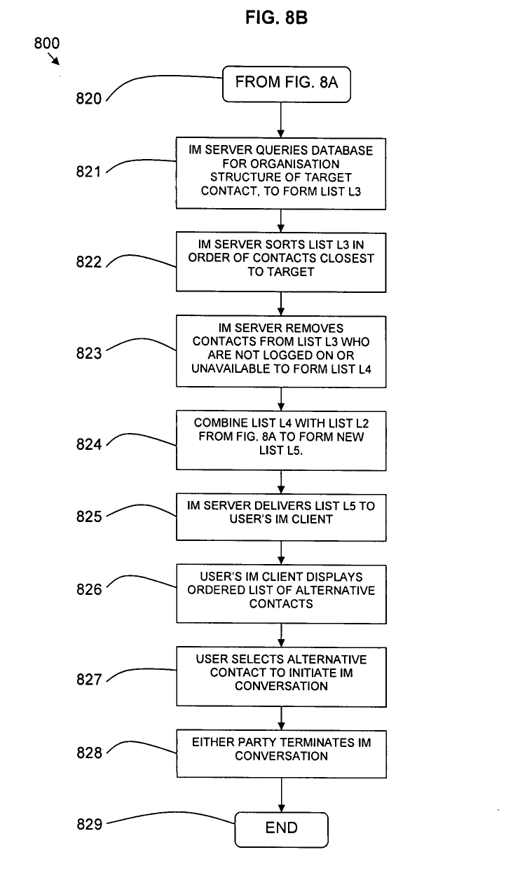

FIGS. 8A and 8B show flow diagrams 800 of a method in accordance with the second embodiment.

The method starts 801 when a user looks up a target contact in his IM client 802. The IM server determines that the target contact is not logged on to the IM server or his client is logged on but signals “auto-away” or “do not disturb” 803.

If the target contact is not logged on, the IM server queries a central server for the recorded desk location of the target contact 804.

Alternatively, if the target contact is logged on but signals “auto-away” or “do not disturb”, the IM server contacts the target contact's laptop to determine the GPS coordinates of the laptop 805. The laptop is assumed to have or be linked to a GPS sensor. The target contact's IM client could query this sensor via an API for the GPS software and then feed the GPS coordinates back to the IM server. The IM server queries a central server for the current desk location of the target contact based on the supplied GPS coordinates 806. The central server holds a look-up table of GPS coordinates against desk location. The actual GPS coordinates of the target contact's laptop are compared with the table in the central server to determine the nearest desk location by trigonometry.

In both cases, the location of the target contact is referred to as X 807.

The IM server queries the central server for a list L1 of people whose desk locations are known to be close to X 808. Nearby desk locations could be identified if desk locations are defined in a systematic manner that is related to physical location (for example, all desks in the same bay have the same prefix in their name). Alternatively, nearby desk locations could be identified from the table in the central server.

The IM server removes 809 all people from the list L1 who are not logged on to the IM server, or who are marked as “auto-away” or “do not disturb”. This results in list L2. The method then proceeds to FIG. 8B 810.

FIG. 8B proceeds 820 from FIG. 8A. The IM server queries a database for the organization structure relating to the target contact 821 to identify alternative contacts with a close social relationship to the target contact. For example, the organization structure may hold information on the target contact's project manager, peers, and subordinates. This results in a list of people called L3.

The IM server sorts list L3 such that people closest to the target contact in the structure are placed at the head of the list 822. This is useful as it is assumed that people closest to the target contact in the organizational structure are more likely to know the whereabouts of the target contact or may be able to answer queries themselves from the user.

The IM server removes all people from list L3 who are logged on to the IM server but who are unavailable, for example by being marked as “auto-away” or “do not disturb” 823. This results in list L4.

The IM server combines list L4 with the list L2 generated in FIG. 8A of the physical proximity contacts, to produce new list L5 824. Processing could be used in the production of list L5. For example, only people who appear in both L2 (physically close to the position of the target contact's computer) and L4 (same project team as the target contact) might be included in list L5. Alternatively, no people might be removed from the union of lists L2 and L4 to make L5, but their position in L5 could be determined based on their positioning in L2 and/or L4. Different weightings could be applied to the two lists, L2 and L4, according to the perceived relative importance of physical and social proximity.

The IM server delivers the ordered list L5 of people to the user's IM client 825. People in the list can be optionally tagged with further identifying information. The tags might identify which people are peers in the same team, who is the target contact's immediate manager, or who is sitting closest to the position of the target contact's computer.

The user's IM client displays an ordered list L5 of icons next to the icon for the target contact 826. The icon closest to that of the target contact would be the person at the head of list L5. Icons can be optionally tagged or displayed with the further identifying information. For example, the shape, size or color of the icons might differ according to the additional information. Further a tool tip could pop up if the user's mouse hovers over an icon to provide more verbose information about that person.

The user selects any one of the people in list L5 to initiate an IM conversation 827. Either party may terminate the IM conversation 828 and the method ends 829.

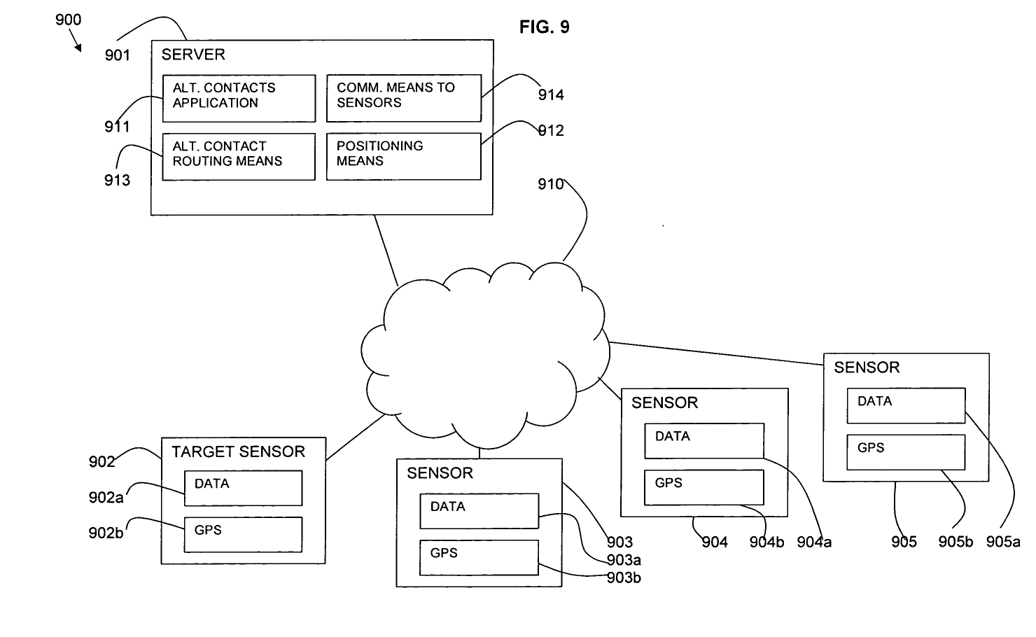

Referring to FIG. 9, a block diagram shows a system 900 for implementing the third example embodiment. A server 901 wishes to communicate with a target contact 902. Multiple alternative contacts 903, 904, 905 may be physically positioned near or remote from the target contact 902. In this embodiment, the contacts 902-905 are not people but are objects, for example in the form of telemetric sensors 902-905. Each sensor 902-905 holds data 902a-905a required by the server 901 and a GPS positioning means 902b-905b to determine the position of the sensor 902-905, if it is mobile.

The server 901 includes communications means 914 for communication with the sensors 902-905 via a network 910. The server 901 includes an alternative contacts application 911 for determining alternative contacts and an alternative contact routing means 913. The server 901 includes a positioning means 912 for determining the closest sensors to a target sensor 902. For example, this may be a GPS system for mobile sensors, or a look-up table of immobile sensor positions.

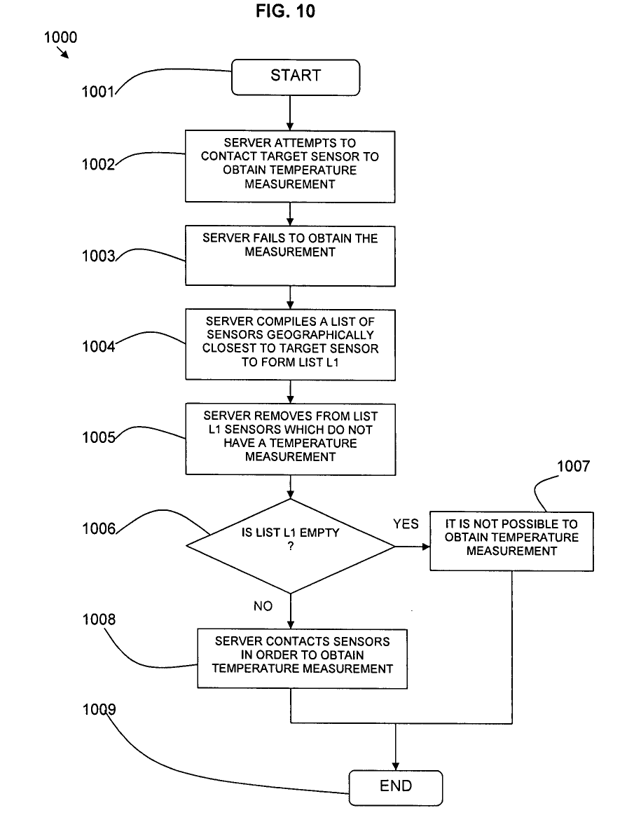

FIG. 10 is a flow diagram 1000 showing a method in accordance with the third example embodiment. The method starts 1001 and a central server attempts to contact a target weather sensor S1 1002 using enterprise messaging to obtain a temperature measurement from within a predetermined time period. For example, the enterprise messaging may be JMS (Java™ Messaging Service, a trade mark of Sun Microsystems, Inc), web services, or proprietary systems such as IBM® WebSphere® MQ (trade marks of International Business Machines Corporation).

The server determines that it cannot obtain the measurement from sensor S1 1003. This may be because the server cannot establish contact with the sensor S1. For example, the sensor S1 might not respond if it is broken, the communication system failed, or its power supply has become depleted. Alternatively, the server may be able to establish contact but the sensor does not have a temperature measurement from within the defined time period. For example, the temperature sensor may have failed or it may be programmed to read temperatures at times too infrequent to be of use for this request.

The server compiles a list L1 of sensors considered to be geographically closest to sensor S1 1004. If the sensors are immobile, this is straightforward as the relative positions can be determined from a look-up table. If the sensors are mobile, the following methods may be used. If sensor S1 is operational and some or all the sensors are able to communicate (for example, by means of WLAN), then sensor S1 may broadcast to detect all other sensors within a pre-defined range of itself (for example, the WLAN range). If sensor S1 is not operational, then the server could request the current GPS coordinates of all its sensors and determine which ones are closest in XYZ space to sensor S1.

The server removes all sensors from list L1 which do not have a temperature sensor or a recent temperature measurement and sensors closest to sensor S1 are at the head of the list 1005. In this embodiment, the social proximity refers to the combination of meteorological variables that are recorded by each sensor. For example, sensor S2 might be geographically closer to sensor S1 than sensor S3, but because sensor S2 records humidity whereas sensor S3 records temperature, sensor S3 is considered to be more closely related to sensor S1 than sensor S2. Sensor S2 is therefore removed from list L1.

It is determined if list L1 is empty 1006. If it is empty, it is not possible to determine a recent temperature measurement at or near sensor S1 1007. If list L1 is not empty, the server contacts the sensor at the head of list L1. If this sensor is not available then the server contacts the next sensor in the list, and so on until it is successful and obtains a recent temperature measurement 1008. The method then ends 1009.

In a further example embodiment, only physical proximity may be used for determining alternative contacts without any social proximity measure. For example, in the third example embodiment of the sensors, the closest sensors to the target sensor may be interrogated without consideration of the data available at the sensors. The sensors can be worked through in order of proximity until the data is obtained, all the sensors have been tried, or all sensors within a pre-defined distance have been tried.

In a still further example embodiment, only social proximity may be used for determining alternative contacts without any physical proximity measure. For example, in the first embodiment, the social proximity of the frequency of email usage between the target contact and each of the alternative contacts may be used to order the alternative contacts regardless of their physical location.

In a still further example embodiment, the technique for locating an alternative contact could be applied recursively. That is, if none of the alternative contacts are available, one of them could be selected as the new ‘target contact’ and the technique applied to this new target until a suitable alternative contact is determined. If none of the alternative contacts are available then one of them could be selected as the new target, and so on. With each successive level of recursion the finally selected target is likely to be more and more remote (socially and physically) from the original target. Also, the user is less likely to want to wait further for a target to be located. Therefore, although the recursion could be applied indefinitely, in practice, depending on the application for this embodiment, the depth of recursion is likely to be restricted to just one or two levels.

The invention can take the form of an entirely hardware embodiment, a software embodiment, or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for communication forwarding, comprising:
determining if a target contact for a communication is unavailable;
ascertaining a plurality of alternative contacts with a relationship to the target contact; and
ordering the alternative contacts by their strength of relationship with the target contact.

2. The method of claim 1, further comprising providing the ordered alternative contacts to a user for selection.

3. The method of claim 1, further comprising automatically routing the communication to the first ordered alternative contact.

4. The method of claim 3, further comprising generating communication messages to inform an originator of the communication of the routing.

5. The method of claim 1, wherein the relationship is a geographical proximity of an alternative contact to the target contact.

6. The method of claim 5, wherein the geographical proximity is determined by positioning technology of a communication apparatus of the target contact and of the alternative contact.

7. The method of claim 6, wherein the communication apparatus is mapped to contact details.

8. The method of claim 1, wherein the relationship is a social proximity of an alternative contact and the target contact.

9. The method of claim 8, wherein the social proximity is one of a social, business, corporate, or organizational relationship between the alternative contact and the target contact.

10. The method of claim 1, wherein the relationship is a frequency of communication between an alternative contact and the target contact.

11. The method of claim 10, wherein the communication is one of a telephone call, an instant message, an email, an SMS message, or a pager message.

12. The method of claim 10, wherein the communications are monitored and a structure maintained of the relationships between contacts.

13. The method of claim 1, wherein the relationship is a combination of geographical proximity of an alternative contact to the target contact, a social proximity of the alternative contact and the target contact, and a frequency of communication contact between the alternative contact and the target contact.

14. The method of claim 1, wherein the relationship is a combination of geographical proximity of an alternative contact to the target contact and a social proximity of the alternative contact and the target contact.

15. The method of claim 1, wherein the relationship is a combination of geographical proximity of an alternative contact to the target contact and a frequency of communication contact between the alternative contact and the target contact.

16. The method of claim 1, wherein the relationship is a combination of a social proximity of an alternative contact and the target contact and a frequency of communication contact between the alternative contact and the target contact.

17. The method of claim 1, wherein the strength of relationship is a comparative measure of the relationship of each of the plurality of alternative contacts to the target contact.

18. The method of claim 1, wherein the method is applied recursively if no alternative contacts are available, further comprising:
designating an alternative contact as the new target contact and applying the method for the new target contact.

19. A method for communication forwarding, comprising:
determining if a target contact for a communication is unavailable;
ascertaining a plurality of alternative contacts with a relationship to the target contact, wherein the relationship is the geographical proximity of an alternative contact to the target contact.
